(19) United States
(12) Patent Application Publication
(10) Pub. No.: US 2025/0298354 A1
(43) Pub. Date: Sep. 25, 2025

(54) IMAGE FORMING APPARATUS

(71) Applicant: CANON KABUSHIKI KAISHA, Tokyo (JP)

(72) Inventor: KENJI FUKUSHI, Chiba (JP)

(21) Appl. No.: 19/086,616

(22) Filed: Mar. 21, 2025

(30) Foreign Application Priority Data
Mar. 25, 2024 (JP) 2024-047848

(51) Int. Cl. G03G 15/00; H04N 1/00

(52) U.S. Cl. CPC G03G 15/5016; H04N 1/00392; H04N 1/00496; H04N 1/00896

(57) ABSTRACT

Disclosed is an image forming apparatus for forming an image on a recording material, including a main body having an image forming portion that forms an image on a recording material; and an operation portion that has a display portion that displays information on image forming and a notification portion that notifies a state of the image forming apparatus, the operation portion being slidably provided in the main body between a first position where the entirety of the display portion is exposed from the apparatus main body and a second position where the display portion is stored in the main body such that at least a part of the display portion is invisible from outside the main body. The notification portion is provided in a position where the notification portion is visible from outside the main body when the operation portion is in the second position.

### BACKGROUND OF THE INVENTION

### Field of the Invention

This invention relates to an image forming apparatus with an operation panel.

### Description of the Related Art

An image forming apparatus for forming an image on a recording material is provided with an operation panel including a display for displaying information on progression state of image formation or various setting content. These days, there is a tendency for such an image forming apparatus of having a larger operation display for improving the visibility of the display and for increasing the amount of information to be displayed.

In an image forming apparatus provided with a larger operation panel, the operation panel might be an obstacle when it is not necessary to use the operation panel like the case where a discharged recording material on which an image has been formed should be taken out. Further, in an image forming apparatus provided with a larger operation panel, the entirety of the apparatus is larger and a foot print of the apparatus is also larger.

In view of this problem, Japanese Patent Application Laid-Open No. 2021-53818 discloses an image forming apparatus whose screen can be enlarged when a larger screen is necessary by accommodating a part of a flexible display with a touch panel in an accommodating portion and by drawing out the display from the accommodating portion as needed.

However, in the apparatus disclosed in Japanese Patent Application Laid-Open No. 2021-53818, a problem that the display might be an obstacle cannot still be solved since the entirety of the display cannot be accommodated in the accommodating portion. Further, in the apparatus disclosed in Japanese Patent Application Laid-Open No. 2021-53818, there is another problem that electric power is wastefully consumed since the screen kept lit even when the display is not used.

### SUMMARY OF THE INVENTION

An image forming apparatus comprising:
an apparatus main body having an image forming portion that forms an image on a recording material;
an operation portion having a display portion that displays information on image forming and whose brightness can be changed, the operation portion being able to be moved between a first position where the entirety of the display portion is exposed from the apparatus main body and a second position where the operation portion is stored in the apparatus main body such that at least a part of the display portion is invisible from outside the apparatus main body,
wherein the display portion has a first brightness when the operation portion is in the first position and the display portion has a second brightness darker than the first brightness when the operation portion is in the second position.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to an embodiment of the present invention.

FIG. 2 is a diagram showing a perspective view of the image forming apparatus according to the embodiment of the present invention in the state where an operation panel is stored.

FIG. 3 is a diagram showing a perspective view of the image forming apparatus according to the embodiment of the present invention in the state where the operation panel is exposed and before the operation panel is rotated.

FIG. 4 is a diagram showing a perspective view of the image forming apparatus according to the embodiment of the present invention in the state where the operation panel is exposed and after the operation panel is rotated.

FIG. 5 is a block diagram showing the configuration of the image forming system including the image forming apparatus according to the embodiment of the present invention.

FIG. 6 is a block diagram showing the configuration of the operation panel of the image forming apparatus according to the embodiment of the present invention.

FIGS. 7A, 7B and 7C are diagrams showing the operation of the operation panel of the image forming apparatus according to the embodiment of the present invention.

FIG. 8 is a flowchart of panel state detection process performed by the image forming apparatus according to the embodiment of the present invention.

FIG. 9 is a flowchart of the control process in case where the display portion is stored, performed by the image forming apparatus according to the embodiment of the present invention.

FIG. 10 is a flowchart of the control process in case where the touch panel is stored, performed by the image forming apparatus according to the embodiment of the present invention.

FIG. 11 is a flowchart of the control process in case where the display portion is exposed, performed by the image forming apparatus according to the embodiment of the present invention.

FIG. 12 is a flowchart of the control process in case where the touch panel is exposed, performed by the image forming apparatus according to the embodiment of the present invention.

### DESCRIPTION OF THE EMBODIMENTS

In the following, embodiments of the present invention will be described with reference to the figures.

### Configuration of Image Forming System

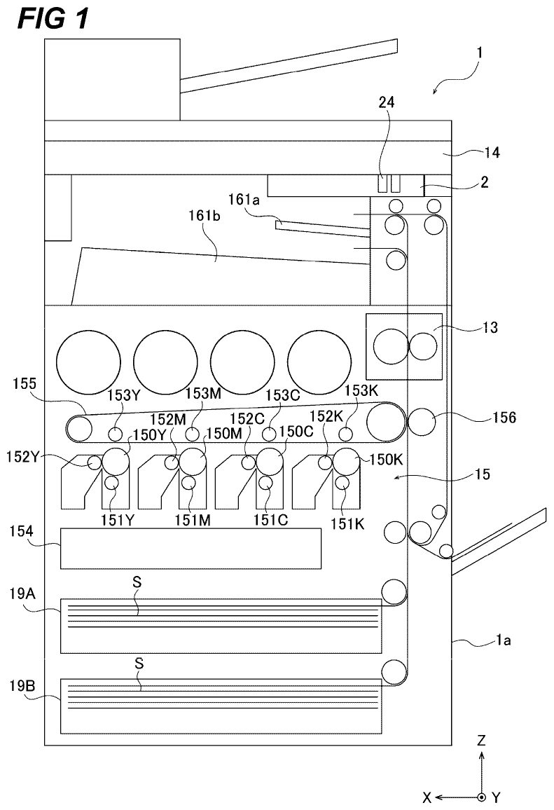

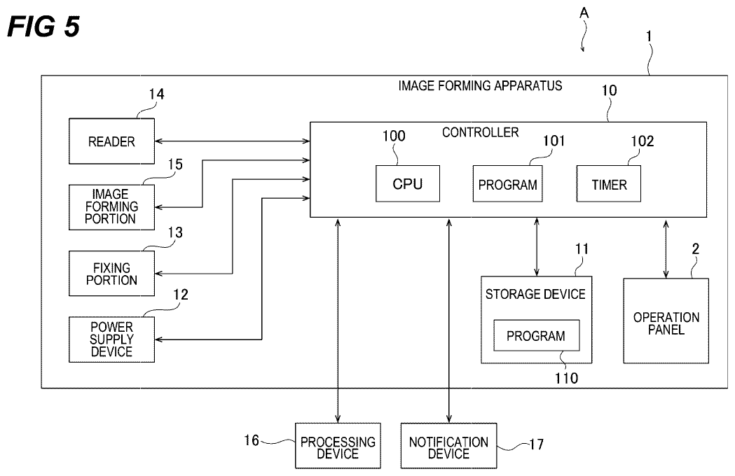

The configuration of the image forming system A according to the embodiment of the present invention will be described in detail with reference to FIGS. 1 to 5.

The image forming system A has the image forming apparatus 1 and the processing device 16 and the notification device 17. The image forming system A can be configured without having the process device 16.

The image forming apparatus 1 forms an image on the sheet S as a recording material and conveys the sheet S on which an image has been formed to the processing device 16 or discharges it outside the image forming apparatus 1. The image forming apparatus 1 discharge the sheet S conveyed by the processing device 16 outside the image forming apparatus 1. Detailed configuration of the image forming apparatus 1 will be described later.

The processing device 16 is connected to the image forming apparatus 1 to expand the function of the image forming apparatus 1 as an option. The processing device 16 performs processes designated by a user such as a staple process, a punch process and a bookbinding process for the sheets S on which images has been formed and which are conveyed by the image forming apparatus 1. The processing device 16 conveys to the image forming apparatus 1 the sheets S for which the processes a user has designated have been performed.

The notification device 17 notifies the state of the image forming apparatus 1.

### Configuration of Image Forming Apparatus

The configuration of the image forming apparatus 1 according to the embodiment of the present invention will be described in detail with reference to FIGS. 1 to 5, and 7.

The image forming apparatus 1 has the apparatus main body 1a, the operation panel 2, the controller 10, the storage device 11, the power supply device 12, the fixing portion 13, the reader 14, the image forming portion 15, the sheet cassette 19A, the sheet cassette 19B, the detection sensor 30, the detection sensor 31, the discharge tray 161a, the discharge tray 161b, the shaft portion 62, the light blocking member 71 and a main body power switch (not shown) of seesaw or tactile type for switching on/off of the main power.

The apparatus main body 1a has the fixing portion 13, the image forming portion 15, the sheet cassette 19A and the sheet cassette 19B.

The operation panel 2 as an operation portion is provided in the apparatus main body 1a of the image forming apparatus 1 such that the operation panel 2 can be stored in the space under the reader 14. The operation panel 2 is provided such that the operation panel 2 can be moved with respect to the apparatus main body 1a in the direction Y or the direction opposite to the direction Y and further, after the operation panel 2 has been moved in the the direction Y, the operation panel 2 can be rotated around a rotation axis parallel with the direction X. The operation panel 2 works under the control of the controller 10. The detailed configuration of the operation portion 2 will be described later.

The controller 10 controls the overall operation of the image forming apparatus 1, the operation of the processing device 16 and the operation of the notification device 17. The controller 10 is provided with the CPU 100, the memory 101, and the timer 102.

The CPU 100 controls the operations of the power supply device 12, the fixing portion 13, the reader 14, the image forming portion 15, the processing device 16, and the notification device 17, which are connected to the controller 10. The CPU 100 reads out the program 110 stored in the storage device 11 and executes it to control the reader 14, the image forming portion 15 and the processing device 16 while using the memory 101. The CPU 100 performs image processing for image data input from the reader 14, stores the image data for which the image processing has been performed into the storage device 11, and transfer the image data to the image forming portion 15 where the image forming process is performed in which an image is formed on the sheet S.

The CPU 100 outputs to the operation panel 2 a control signal for controlling the operation of the operation panel 2. The CPU 100 reads out the display image data stored in the storage device 11 and outputs the data to the operation panel 2 to display the image on the operation panel 2.

The CPU 100 controls the operation of the image forming apparatus 1 based on the calculation result of coordinates of the touch position on the touch panel 22 (described later) of the operation panel 2 indicated by an electrical signal input from the operation panel 2. The CPU 100 performs the mode shift operation (described later) based on the count value counted by the timer 102. In the mode shift operation, the image forming apparatus 1 shifts from the stand-by mode to the sleep mode as a power saving mode, in which less power is consumed.

The CPU 100 performs a panel state detection process (described later) for judging the state of the operation panel 2 based on an electrical signal input from the detection sensors 30 and 31. The CPU 100 outputs to the operation panel 2 an electrical signal in response to the state of the operation panel 2 judged by performing the panel state detection process. The CPU 100 adjusts the brightness of the display portion 21 (described later) of the operation panel 2 by performing the control process in case where the display portion is stored (described later) or the control process in case where the display portion is exposed (described later) in response to the state of the operation panel 2 judged by performing the panel state detection process.

In the memory 101, the data required when the CPU 100 executes the program 110 are temporarily stored.

The timer 102 times by counting the counting value under the control of CPU 100 when the CPU performs various processes.

In the storage device 11, stored are the various programs 110 relating to the control of the image forming apparatus 1, the display image data, and the printing data. The various programs 110 stored in the storage device 11 include a software group for functioning for the controller 10 to perform the various processes. The display image data stored in the storage device 11 are ones for displaying an image on the operation panel 2.

The power supply device 12 receives electric power via an outlet (not shown) from the commercial power line. The power supply device 12 supplies the electric power supplied from the commercial power line to the respective devices of the image forming system A under the control of the CPU 100.

The fixing portion 13 fixes the toner image on the sheet S by applying heat and pressure to the sheet S on which the toner image has been secondarily transferred that is conveyed by the intermediate transfer belt 155 and the secondary transfer roller 156. The fixing portion 13 conveys the sheet S on which the toner image has been fixed to the discharge tray 161a or the discharge tray 161b.

The reader 14 optically reads the image of a document placed on a glass surface (not shown), converts it into image data, and outputs the converted image data to the image forming portion 15.

The image forming portion 15 performs the image forming process for forming an image on the sheet S fed by the sheet cassette 19A or the sheet cassette 19B based on the image data input by the reader 14. The image forming portion 15 has the photosensitive drums 150Y, 150M, 150C and 150K, the charging devices 151Y, 151M, 151C and 151K, the developing devices 152Y, 152M, 152C and 152K, the primary transfer rollers 153Y, 153M, 153C and 153K, the laser scanner unit 154, the intermediate transfer belt 155, and the secondary transfer roller 156.

The photosensitive drums 150Y, 150M, 150C and 150K are driven to rotate by a driving device (not shown). A toner image is formed on the photosensitive drums 150Y, 150M, 150C and 150K by the the charging devices 151Y, 151M, 151C and 151K, the developing devices 152Y, 152M, 152C and 152K, and the laser scanner unit 154,

The charging devices 151Y, 151M, 151C and 151K respectively charge the surfaces of the photosensitive drums 150Y, 150M, 150C and 150K.

The developing device 152Y forms a yellow toner image on the photosensitive drum 150Y by attaching yellow toner to an electrostatic latent image formed on the surface of the photosensitive drum 150Y by the laser scanner unit 154.

The developing device 152M forms a magenta toner image on the photosensitive drum 150M by attaching magenta toner to an electrostatic latent image formed on the surface of the photosensitive drum 150M by the laser scanner unit 154.

The developing device 152C forms a cyan toner image on the photosensitive drum 150C by attaching cyan toner to an electrostatic latent image formed on the surface of the photosensitive drum 150C by the laser scanner unit 154.

The developing device 152K forms a black toner image on the photosensitive drum 150K by attaching black toner to an electrostatic latent image formed on the surface of the photosensitive drum 150K by the laser scanner unit 154.

By the primary transfer bias being applied, the primary transfer roller 153Y primarily transfers the yellow toner image formed on the surface of the photosensitive drum 150Y by the developing device 152Y onto the intermediate transfer belt 155.

By the primary transfer bias being applied, the primary transfer roller 153M primarily transfers the magenta toner image formed on the surface of the photosensitive drum 150M by the developing device 152M onto the intermediate transfer belt 155 such that the magenta toner image is superimposed on the yellow toner image formed on the intermediate transfer belt 155.

By the primary transfer bias being applied, the primary transfer roller 153C primarily transfers the cyan toner image formed on the surface of the photosensitive drum 150C by the developing device 152C onto the intermediate transfer belt 155 such that the cyan toner image is superimposed on the yellow toner image and magenta toner image formed on the intermediate transfer belt 155.

By the primary transfer bias being applied, the primary transfer roller 153K primarily transfers the black toner image formed on the surface of the photosensitive drum 150K by the developing device 152K onto the intermediate transfer belt 155 such that the black toner image is superimposed on the yellow toner image, the magenta toner image and cyan toner image formed on the intermediate transfer belt 155.

The image data output from the reader 14 or the image data transmitted from an external device (not shown) via network and received is input to the laser scanner unit 154. The laser scanner unit 154 irradiates the surfaces of the photosensitive drums 150Y, 150M, 150C and 150K charged by the charging devices 151Y, 151M, 151C and 151K with a laser beam according to the input image data to form electrostatic latent images on the surfaces of the photosensitive drums 150Y, 150M, 150C and 150K.

A full-color toner image is formed on the intermediate transfer belt 155 by the respective toner images being superimposed by the primary transfer rollers 153Y, 153M, 153C and 153K and being primarily transferred.

The secondary transfer roller 156 forms a secondary transfer portion along with the intermediate transfer belt 155. By a secondary transfer bias being applied, in the secondary transfer portion, the secondary transfer roller 156 secondarily transfer the full-color toner image on the intermediate transfer belt 155 onto the sheet S fed from the sheet cassette 19A or the sheet cassette 19B. The secondary transfer roller 156 conveys the sheet S on which the full-color toner image has been secondarily transferred to the fixing portion 13 along with the intermediate transfer belt 155.

In the sheet cassette 19A, sheets S are accommodated.

In the sheet cassette 19A, sheets S are accommodated.

The detection sensor 30 as a first detection sensor is provided under the reader 14. The detection sensor 30 is a photosensor of photo-interrupter type having a light emitting portion (not shown) that emits light and a light receiving portion (not shown) that receives the light emitted from the light emitting portion. The detection sensor 30 detects the light blocking member 71 that moves together with the operation panel 2 and the shaft portion 62 and outputs an electrical signal according to a detection result to the controller 10.

The detection sensor 31 as a second detection sensor is provided under the reader 14. The detection sensor 31 is a photosensor of photo-interrupter type having a light emitting portion (not shown) that emits light and a light receiving portion (not shown) that receives the light emitted from the light emitting portion. The detection sensor 31 is provided in a position deferent from the one in which the detection sensor 30 is provided in the direction Y that is a moving direction in which the operation panel 2 moves. The detection sensor 31 detects the light blocking member 71 that moves together with the operation panel 2 and the shaft portion 62 and outputs an electrical signal according to a detection result to the controller 10.

The operation panel 2 is connected to the shaft portion 62. The shaft portion 62 moves together with the operation panel 2.

The light blocking member 71 is provided on the shaft portion 62. The light blocking member 71 moves together with the shaft portion 62.

The sheet S on which a conveyed toner image has been fixed by the fixing portion 13 is discharged via the processing device 16 onto the discharge tray 161a or is discharged as it is not via the processing device 16 onto the discharge tray 161a.

The sheet S on which a conveyed toner image has been fixed by the fixing portion 13 is discharged via the processing device 16 onto the discharge tray 161b or is discharged as it is not via the processing device 16 onto the discharge tray 161b.

### Configuration of Operation Panel

The configuration of the operation panel 2 of the image forming apparatus 1 according to the embodiment of the present invention will be described with reference to FIGS. 1 to 6.

The operation panel 2 has the panel controller 20, the display portion 21, the touch panel 22, the operation sound generating portion 23, the state display portion 24, the key input portion 25, the IF portion 26, and the touch panel controller 220.

The panel controller 20 is connected to the controller 10 via the IF portion 26 and controls the overall operation of the operation panel 2 under the control of the CPU 100. The panel controller 20 is provided with the CPU 200, the ROM 201, the RAM 202, and the timer 203.

The CPU 200 as an output portion executes the control program stored in the ROM 201 according to the control signal input via the IF portion 26 from the CPU 100 to perform various arithmetic processes. By executing the control program, the CPU 200 controls the operations of the display portion 21, the operation sound generating portion 23, the state display portion 24, the key input portion 25, the IF portion 26 and the touch panel portion 220.

The CPU 200 switches between the image of the image data previously stored in the ROM 201 and the image of the display image data input from the CPU 100 via the IF portion 26 for the display portion 21 to display it. The CPU 200 calculates the coordinates of the touch position on the touch panel 22 based on the coordinate data input from the touch panel controller 220 and outputs an electrical signal as a signal in response to a touch position according to the calculation result of the coordinates of the touch position to the CPU 100 via the IF portion 26. When a user's operation for the touch panel 2 should be cancelled, the CPU 200 does not output an electrical signal in response to the calculation result of the coordinates of the touch position.

The CPU 200 performs the control process in case where the touch panel is stored and the control process in case where the touch panel is exposed.

In the ROM 201, various programs such as a control program in relation to the control of the operation panel 2 and information and data in relation to the connection with the image forming apparatus 1 are stored. The information in relation to the connection includes the information on the fact that the connection with the image forming apparatus 1 has been established and the information obtained from the image forming apparatus 1. The information obtained from the image forming apparatus 1 includes the information on the state of the image forming apparatus 1 such as standby mode, sleep mode, and error detection, and the count information such as number of printed sheets.

The RAM 202 is used as a working area during the arithmetic operation by the CPU 200, where data are temporarily stored.

The timer 203 times and counts the count value when the CPU 200 performs various processes under the control of CPU 200.

The display portion 21 is a liquid panel that displays the image of image data previously stored in the ROM 201 or the image of display image data input from the controller 10 via the IF portion 26 under the control of the panel controller 20. The images to be displayed on the display portion 21 include the images of information on the image formation such as the number of sheets on which an image is formed and the sizes of the sheets S on which an image is formed or the images of input keys for setting the values about reading of images such as document sizes.

The image of the image data stored in the ROM 201 of the operation panel 2 and the image of the display image data the operation panel 2 receives from the controller 10 are switched and displayed on the display portion 21 under the control of the CPU 200. The brightness of the backlight of the display portion 21 is changeable by the control of the CPU 100.

The touch panel 22 is disposed on the display portion 21. The touch panel 22 is configured to be visible by the screen of the display portion 21 being transparent. The touch panel 22 is connected to the panel controller 20 via the touch panel controller 220. The touch panel 22 detects a touch operation by a user for an image displayed on the display portion 21 and outputs an electrical signal according to the detection result to the touch panel controller 220.

The operation sound generating portion 23 generates an operation sound according to the operation for the touch panel 22 under the control of the panel controller 20.

The state display portion 24 has a LED that notifies the state of the image forming apparatus 1 to a user. The state display portion 24 turns on and turns off the LED according to the state of the image forming apparatus 1, and changes the state of emitting light under the control of the CPU 200. The states of the image forming apparatus 1 include the state where a job is being performed, the state where an error occurs such as the lack of sheets or the jam, the state where a component failure is doubted, and the state where the cover of the image forming apparatus 1 is opened. For example, when the conveyance of the sheet S is stopped due to a jam occurring in the apparatus main body 1a during sheet passing, the state display portion 24 notifies this to a user by blinking or lighting.

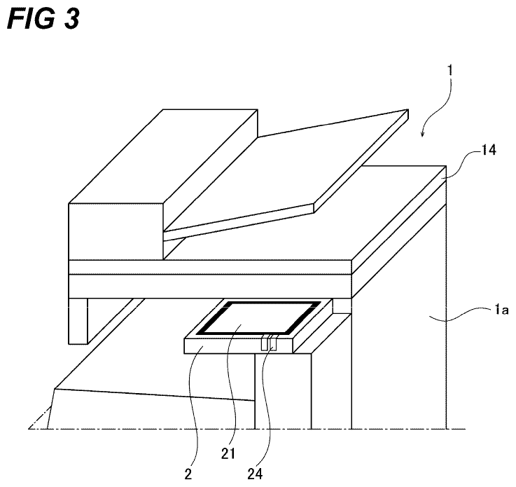

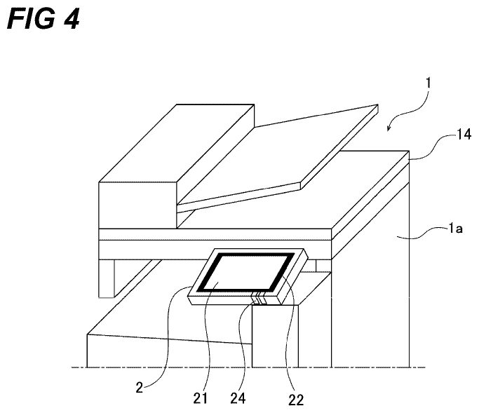

The key input portion 25 is provided on the operation panel 2 at the location outside the display portion 21 and includes hardware keys such as a key for starting the job of image forming apparatus 1, the numeric keys for inputting numerical values, and a key for instructing the shift to the sleep mode. The key input portion 25 receives the setting of image forming apparatus 1 or the input of job instructions by the above keys from a user and outputs an electrical signal according to the received inputs to the panel controller 20. In FIGS. 3 and 4, the key input portion 25 of the operation panel 2 is omitted.

The IF portion 26 connects the CPU 100 of the controller 10 with the CPU 200 of the panel controller 20.

The touch panel controller 220 operates under the control of the panel controller 20. The touch panel controller 220 detects a touch position on the touch panel 22 by a user and outputs to the CPU 200 the coordinate data according to the detected touch position.

The state sound generation portion that generates sound in response to the state of the image forming apparatus 1 such as a speaker may be provided on the operation panel 2 alternatively to or in addition to the state display portion 24. The operation panel 2 has both the display portion 21 and the touch panel 22. However, the configuration of the operation panel 2 is not limited to only this one and may have a touch panel display as a display portion with both the functions of the display portion 21 and the touch panel 22. In this case, the touch panel display accepts the touch operation by a user. When a user perform a touch operation on the touch panel display, the CPU 200 calculates the coordinates corresponding to the touch position of the user on the surface of touch panel display and outputs an electrical signal based on the calculated coordinates.

A user can perform an input by the input portion displayed on the display portion 21 or by touching a key button with the fingers via the touch panel 22. With this configuration, the setting for the image formation such as the number of sheets on which an image is formed and the sizes of the sheets S on which an image is formed or the setting for reading of images such as document sizes can be performed.

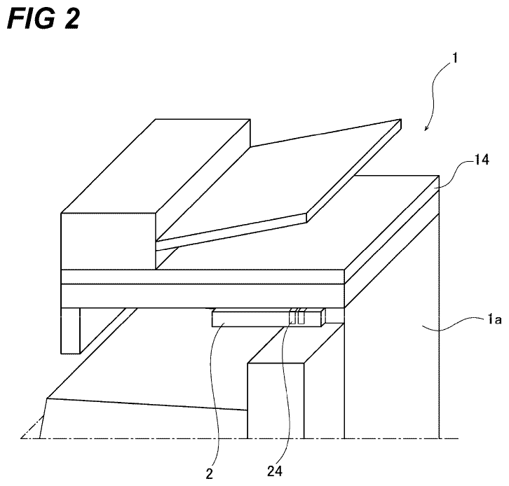

The operation panel 2 configured above is provided in the apparatus main body 1a such that the operation panel 2 is movable between the stored position in which the operation panel 2 is in the stored state as shown in FIG. 2 and the exposed position in which the operation panel 2 is in exposed state as shown in FIG. 3. Further, as shown in FIG. 4, the operation panel 2 is provided in the apparatus main body 1a such that the operation panel 2 is rotatable around the rotational axis in parallel with the direction X in the exposed state.

The exposed position in which the operation panel 2 is in the exposed state is a first position in which the entire of each of the display portion 21, the touch panel 22, and the key input portion 25 is exposed from the apparatus main body 1a. The stored position in which the operation panel 2 is in the stored state is a second position in which at least a part of each of the display portion 21, the touch panel 22, and the key input portion 25 is stored in the apparatus main body 1a and is invisible from outside. The stored position includes the third position in which the entirety of each of the display portion 21, the touch panel 22, and the key input portion 25 is stored in the apparatus main body 1a and is invisible from outside.

When the operation panel 2 is in the exposed state in which the operation panel 2 is in the exposed position, the entirety of the display portion 21 is visible from outside. Further, when the operation panel 2 is in the exposed state in which the operation panel 2 is in the exposed position, the entirety of the touch panel 22 is in the state of being operational for the touch operation by a user and the entirety of the key input portion 25 is in the state of being operational for the push operation.

When the operation panel 2 is in the stored state in which the operation panel 2 is in the stored position, at least a part of the display portion 21 is invisible from outside, but at least a part of the display portion 21 is in a state of visible from outside. Further, when the operation panel 2 is in the stored state in which the operation panel 2 is in the stored position, at least a part of the touch panel 22 is in the state of not being able to be operational by a user and at least a part of the key input portion 25 is in the state of not able to be operational by a user.

When the operation panel 2 is in the exposed position, the operation panel 2 works based on the touch operations for the touch panel 22 and when the operation panel 2 is in the stored position, the operation panel 2 does not work based on the touch operations for the touch panel 22.

When the operation panel 2 is in the exposed position, the CPU 200 controls the brightness of the display portion 21 to a first brightness and when the operation panel 2 is in the stored position, the CPU 200 controls the brightness of the display portion 21 to a second brightness that is darker than the first brightness. Further, when the operation panel 2 is in the third position, the CPU 200 controls the brightness of the display portion 21 to a third brightness that is darker than the second brightness. The case where the display portion is in the second brightness or in the third brightness includes the case where the display portion 21 is turned off.

### Operation of Image Forming Apparatus

The operation of the image forming apparatus 1 according to the first embodiment of the present invention will be described with reference to FIGS. 1 to 6.

When an image forming job is input on the touch panel 22 of the operation panel 2, the controller 10 receives the image forming job from the touch panel 22 via the touch panel controller 220, the panel controller 20, and the IF portion 26 to start the image forming operation.

When the image forming operation starts, the sheet S stored either in the sheet cassette 19A or in the sheet cassette 19B, is sent to the secondary transfer portion formed by the intermediate transfer belt 155 and the secondary transfer roller 156.

In the image forming portion 15, the surface of the photosensitive drum 150Y is charged by the charging device 151Y.

Next, the laser scanner unit 154 irradiates the surface of the photosensitive drum 150Y with a laser beam according to the image data of a document read by the reader 14 or the image data received from the external device (not shown) via a network. As a result of this, an electrostatic latent image is formed on the surface of the photosensitive drum 150.

Next, developing device 152Y attaches yellow toner to the electrostatic latent image formed on the surface of the photosensitive drum 150Y to form a yellow toner image on the surface of the photosensitive drum 150Y.

Next, the toner image formed on the photosensitive drum 150Y is primarily transferred onto the intermediate transfer belt 155 by the primary transfer roller 153Y.

By the similar process, magenta, cyan, and black toner images are respectively formed on the photosensitive drums 150M, 150C, 150K. By the primary transfer bias being applied to the primary transfer rollers 153M, 153C, and 153K, these toner images are transferred in a superimposed manner on the yellow toner image on the intermediate transfer belt 155. As a result, a full-color toner image is formed on the intermediate transfer belt 155 according the image signal.

The full-color toner image formed on the intermediate transfer belt 155 is conveyed to the secondary transfer portion by the rotation of the intermediate transfer belt 155.

Next, the full-color toner image formed on the intermediate transfer belt 155 and conveyed to the secondary transfer portion is transferred on the sheet S that is conveyed by the sheet cassette 19A or the sheet cassette 19B in the secondary transfer portion.

The sheet S on the a toner image has been transferred is conveyed to the fixing portion where the toner image is fixed by the heating and pressing processes.

The sheets S on which the toner images have been fixed are conveyed to the processing device 16. When a user designates the staple process, the punch process or the bookbinding process, the designated process is performed for the sheets S and the sheets S are discharged on the discharge tray 161a. When a user does not designate the staple process, the punch process or the bookbinding process or when the processing device 16 is not connected, the sheets S are discharged on the discharge tray 161b without these processes being performed.

### Mode Shit Operation of Image Forming Apparatus

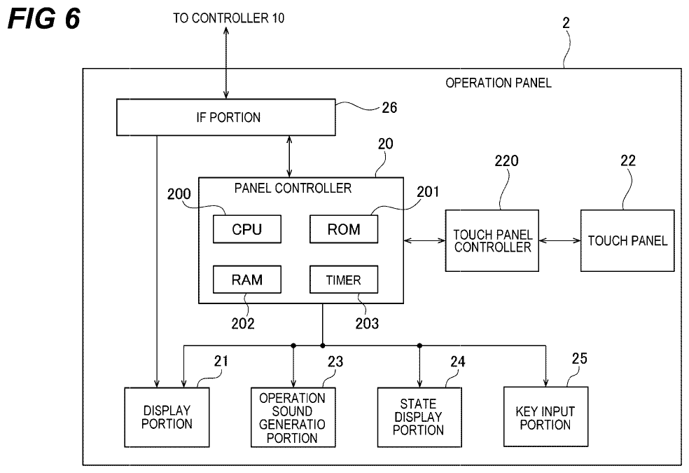

The mode shift operation of the image forming apparatus 1 according to the embodiment of the present invention will be described with reference to FIG. 6.

The CPU 100 is able to perform the stand-by mode as a first electric power mode in which an image can be formed on the sheet S and the mode shift operation for shifting to the sleep mode as a second electric power mode whose power consumption is less than that of the stand-by mode.

In the stand-by mode, the power supply device 12 supplies electric power to the controller 10 and the devices to be used, and does not supply electric power to the devices not to be used under the control of the CPU 100. For example, when a user chooses to read an image, the power supply device 12 supplies electric power to the reader 14 that is the device to be used and does not supply electric power to the image forming portion 15 and the processing device 16 that are the devices not to be used.

When a predetermined time period as a second time period elapses in the case where the operation panel 2 is in the exposed position and the image forming apparatus 1 is in the stand-by mode, the CPU 100 performs the mode shift operation for shifting the image forming apparatus 1 into the sleep mode. When the shift instruction to the sleep mode from a user via the touch panel 22 has been accepted, the CPU 100 performs the mode shift operation for shifting the current mode from the stand-by mode to the sleep mode. The CPU 100 performs the mode shift operation for shifting to the sleep mode during the control process in the case where display portion is stored (described later).

When the current mode shifts from the stand-by mode to the sleep mode, the power supply device 12 stops the supply of electric power to the devices whose electric power has been supplied during the stand-by mode according to the control of the CPU 100.

When the CPU 100 detects an input from a user in the sleep mode, the CPU 100 performs the mode shift operation that returns the sleep mode to the stand-by mode. For example, when the CPU 100 accepts the input of the instruction to return the sleep mode to the stand-by mode from a user on the touch panel 22 in the sleep mode, the CPU 100 performs the mode shift operation to return the sleep mode to the stand-by mode.

Even when there is not an input from a user in the sleep mode, but when there is an input of the detection result from the reader 14 that a document is put on the reader 14, the CPU 100 performs the mode shift operation to return the sleep mode to the stand-by mode. Further, the CPU 100 performs the mode shift operation for shifting to the stand-by mode in the control process in the case where display portion is exposed.

### State Detection Method of Operation Panel

The state detection method of the operation panel 2 of the image forming apparatus 1 according to the embodiment of the present invention will be described with reference to FIGS. 2 to 4, 7A to 7C.

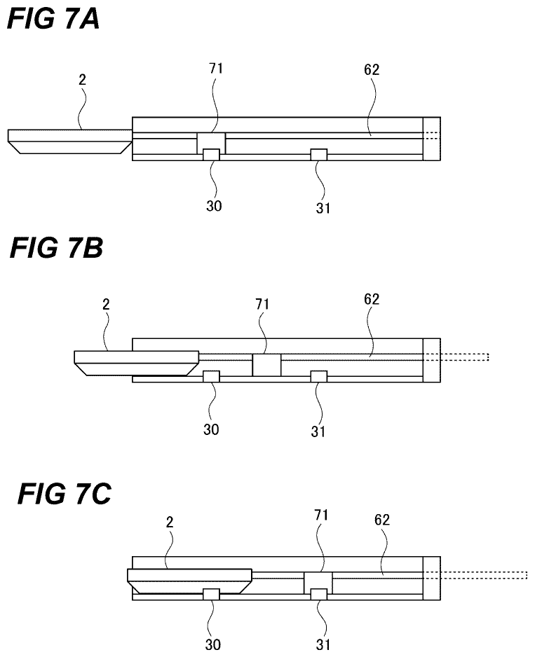

FIG. 7A shows the exposed state in which the operation panel 2 is in the exposed position. FIG. 7B shows the intermediate state in which the operation panel 2 is in the intermediate position between the exposed position as a second position and the stored position. FIG. 7C shows the stored state where the operation panel 2 is in the stored position.

In FIGS. 7A, 7B and 7C, the light emitting portions and light receiving portions of the detection sensors 30 and 31 are disposed such that the light emitting portions and light receiving portions are distanced from each other in the direction perpendicular to the sheet surface of FIGS. 7A, 7B and 7C. The light blocking member 71 passes through the space between the light emitting portion and the light receiving portion of the detection sensor 30 and through the space between the light emitting portion and the light receiving portion of the detection sensor 31. Further, the operation panel 2 has a recess (not shown) through which light emitted from the light emitting portion of the detection sensor 30 can reach the light receiving portion of the detection sensor 30 without blocking the light emitted from the light emitting portion of the detection sensor 30 in the state shown in FIG. 7C.

When the operation panel 2 is in the exposed state (state shown in FIG. 3), the detection sensor 30 detects the light blocking member 71 by the light emitted from the light emitting portion of the detection sensor 30 being blocked by the light blocking member 71 as shown in FIG. 7A. When the operation panel 2 is in the exposed state, the detection sensor 31 does not detect the light blocking member 71 by the light emitted from the light emitting portion of the detection sensor 31 not being blocked by the light blocking member 71 and being received by the light receiving portion of the detection sensor 31 as shown in FIG. 7A. In this case, the CPU 100 judges that the operation panel 2 is in the exposed state according to the detection results of the detection sensor 30 and the detection sensor 31.

When the operation panel 2 is in the intermediate state, the detection sensor 30 does not detect the light blocking member 71 by the light emitted from the light emitting portion of the detection sensor 30 being received by the receiving portion of the detection sensor 30 without being blocked by the light blocking member 71 as shown in FIG. 7B. When the operation panel 2 in the intermediate state, the detection sensor 31 does not detect the light blocking member 71 by the light emitted from the light emitting portion of the detection sensor 31 being received by the light receiving portion of the detection sensor 31 without being blocked by the light blocking member 71 as shown in FIG. 7B. In this case, the CPU 100 judges that the operation panel 2 is in the intermediate state according to the detection results of the detection sensor 30 and the detection sensor 31.

When the operation panel 2 is in the stored state (state shown in FIG. 2), the detection sensor 30 does not detect the light blocking member 71 by the light emitted from the light emitting portion of the detection sensor 30 being received by the receiving portion without being blocked by the light blocking member 71 as shown in FIG. 7C. The detection sensor 31 detects the light blocking member 71 by the light emitted from the light emitting portion of the detection sensor 31 being blocked by the light blocking member 71 as shown in FIG. 7C. In this case, the CPU 100 judges that the operation panel 2 is in the stored state according to the detection results of the detection sensor 30 and the detection sensor 31.

The operation panel 2 is configured not to move from the stored position shown in FIG. 7C in the depth direction (rightward direction in FIG. 7C) by a stopper (not shown).

The detection sensor 30 and the detection sensor 31 are not limited to photosensors and can be configured by mechanical sensors such as switches. The detection and non-detection of the light blocking member 71 by the detection sensor 30 and the detection sensor 31 can be opposite to the above description.

### Panel State Detection Process

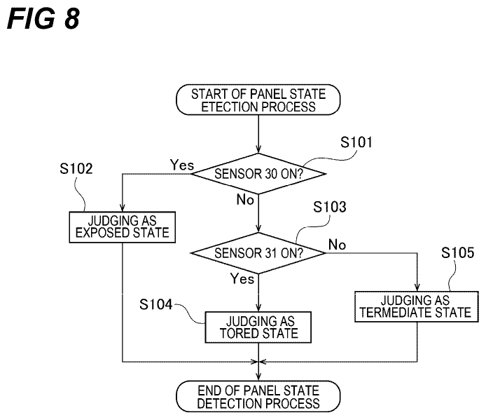

The panel state detection process performed by the image forming apparatus 1 according to the first embodiment of the present invention will be described in detail with reference to FIG. 8.

The panel state detection process shown in FIG. 8 starts at the time when the main power supply of the image forming apparatus 1 is turned on. In FIG. 8, “ON” refers to the fact that the detection sensor 30 or the detection sensor 31 detects the light blocking member 71.

First, the CPU 100 judges whether the detection sensor 30 detects the light blocking member 71 (“ON” or not) based on an electrical signal in response to the detection result input from the detection sensor 30 (step S101).

When the detection sensor 30 detects the light blocking member 71 (step S101: Yes), the CPU 100 judges that the operation panel 2 is in the exposed state (step S102), performs the control for the case in which the operation panel 2 is in the exposed state, and after that, completes the panel state detection process. In this case, the CPU 100 notifies the CPU 200 of the operation panel 2 that the operation panel 2 is in the exposed state by outputting an electrical signal indicating that the operation panel 2 is in the exposed state to the operation panel 2.

In contrast, when the detection sensor 30 does not detect the light blocking member 71 (step S101: No), the CPU 100 judges whether the detection sensor 31 detects the light blocking member 71 (“ON” or not) based on an electrical signal input from the detection sensor 31 (step S103).

When the detection sensor 31 detects the light blocking member 71 (step S103: Yes), the CPU 100 judges that the operation panel 2 is in the stored state (step S104), performs the control for the case in which the operation panel 2 is in the stored state, and after that, completes the panel state detection process. In this case, the CPU 100 notifies the CPU 200 of the operation panel 2 that the operation panel 2 is in the stored state by outputting an electrical signal indicating that the operation panel 2 is in the stored state to the operation panel 2.

In contrast, when the detection sensor 31 does not detect the light blocking member 71 (step S103: No), the CPU 100 judges that the operation panel 2 is in the intermediate state (step S105), performs the control for the case in which the operation panel 2 is in the intermediate state, and after that, completes the panel state detection process. In this case, the CPU 100 notifies the CPU 200 of the operation panel 2 that the operation panel 2 is in the intermediate state by outputting an electrical signal indicating that the operation panel 2 is in the intermediate state to the operation panel 2.

The CPU 100 controls the operation of the operation panel 2 in response to the state of the operation panel 2 judged by the panel state detection process. Specifically, when the operation panel 2 is in the exposed position, the CPU 100 controls the operation of the operation panel 2 based on an electrical signal in response to the calculation result of the coordinates of the touch position on the touch panel 22 input from the operation panel 2. The CPU 100 does not control the operation of the operation panel 2 when the operation panel 2 is in the stored position.

According to the state of the operation panel 2 judged by the panel state detection process, the CPU 200 outputs an electrical signal in response to the calculation result of the coordinates of the touch position on the touch panel 22. Specifically, when the operation panel 2 is in the exposed position, the CPU 200 outputs an electrical signal in response to the calculation result of the coordinates of the touch position, and when the operation panel 2 is in the stored position, the CPU 200 does not output an electrical signal in response to the calculation result of the coordinates of the touch position. Further, the CPU 200 may be configured to output an electrical signal in response to the calculation result of the coordinates of the touch position irrespective of the position of the operation panel 2.

### Control Process in the Case where Display Portion is Stored

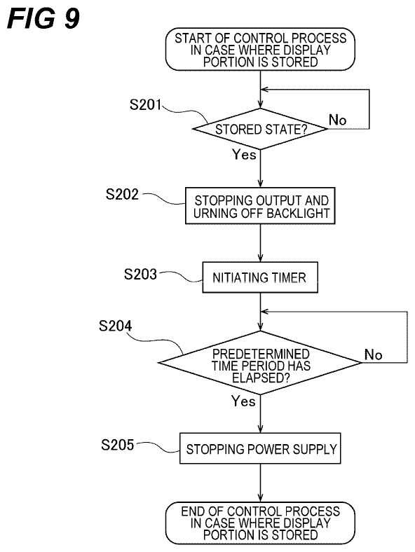

The control process in the case where display is stored performed by the image forming apparatus 1 according to the first embodiment of the present invention will be described in detail with reference to FIG. 9.

The control process in the case where display is stored shown in FIG. 9 starts at the time when it is judged that the operation panel 2 is in the intermediate state or the exposed state by the panel state detection process shown in FIG. 8.

First, the CPU 100 judges whether the result of the state of the operation panel 2 judged by the panel state detection process shown in FIG. 8 is the stored state or not (step S201).

When the result judged by the panel state detection process is the exposed state or the intermediate state (step S201: No), the CPU 100 watches whether the operation panel 2 shifts from the exposed state or the intermediate state to the stored state or not.

In contrast, when the result judged by the panel state detection process is the stored state (step S201: Yes), the CPU 100 performs the process necessary for the operation panel 2 to shift from the exposed state or the intermediate state to the stored state.

Specifically, the CPU 100 stops the output of the display image data to the operation panel 2. The CPU 100 outputs to the CPU 200 a control signal for changing a value of the brightness of the display portion from the first brightness to the second brightness. When the control signal output from the control signal output from the CPU 100, the CPU′ 200 turns off the backlight of the display portion 21 (step S202). When a control signal is input while a control is being performed for displaying the image data stored in the ROM 201 on the display portion 21, the CPU 200 performs a control such that an image is not displayed on the display portion 21.

Next, the CPU 100 activates the timer 102 for shifting to the sleep mode (step S203).

Next, the CPU 100 judges whether a predetermined time period as a first time period has elapsed based on the count value counted by the timer 102 (step S204). The predetermined time period as the first time period is shorter than the predetermined time period as the second time period after which period elapses the image forming apparatus shifts to the sleep mode. The predetermined time period as the first time period and the second time period as the second time period can be changed by the operation of a user on the touch panel 22.

When the predetermined time period has not elapsed (step S204: No), the CPU 100 waits for the predetermined time period to elapse by repeating the process of the step S204.

In contrast, when the predetermined time period has elapsed (step S204: Yes), the CPU 100 shifts to the sleep mode, so that the CPU stops the supply of power of the power device 12 to the operation panel 2 (step S205), thereafter the CPU 100 completes the control process in the case where the display portion is stored. As described above, when the current mode is in the stand-by mode and the operation panel 2 located in the exposed position has moved to the stored position and the predetermined time period as the first period of time has elapsed, the CPU shifts the operation panel 2 to the sleep mode.

In the step S204 of the control process in the case where the display portion is stored, the predetermined period time can be set to “0” seconds. In this case, immediately after the completion of the step S204, the CPU 100 stops the supply of power of the power device 12 to the operation panel 2. Further, when the operation panel 2 has shifted from the intermediate state to the stored state, the CPU 100 stops the supply of power of the power device 12 to the operation panel 2. However, the configuration is not limited to this one and the configuration may be that when the operation panel 2 has shifted from the exposed state to the intermediate state, the CPU 100 stops the supply of power of the power device 12 to the operation panel 2. In this case, the CPU 100 may perform the control such that while the operation panel 2 shifts from the intermediate state to the stored state, the backlight may be gradually darker.

By performing the above described control process in the case where the display portion is stored, the power consumption can be reduced.

### Control Process in the Case where Touch Panel is Stored

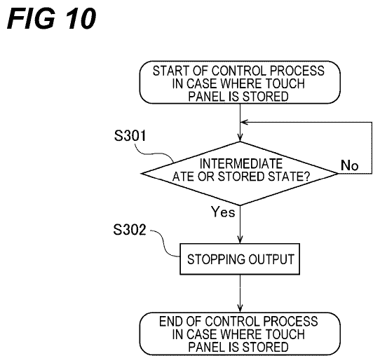

The control process in the case where the touch panel is stored, performed by the image forming apparatus 1 according to the first embodiment of the present invention will be described in detail with reference to FIG. 10.

The control process in the case where the touch panel is stored, shown in FIG. 10 starts at the time when an electrical signal output from the CPU 100 indicating that the operation panel 2 is in the exposed state is input to the CPU 200.

First, the CPU 200 judges whether the operation panel 2 is in the stored state or in the intermediate state or not based on an electrical signal input from the CPU 100 in response to the state of the operation panel 2 (step S301).

When the operation panel 2 is in the exposed state (step S302: No), the CPU 200 repeats the process of the step S301.

In contrast, when the operation panel 2 is in the stored state or in the intermediate state (step S301: Yes), the process necessary for the operation panel 2 to shift from the exposed state to the stored state. Specifically, the CPU 200 stops the output to the controller 10 a signal in response to the detection result of the position of the coordinates indicated by an electrical signal input from the touch panel controller 220 (step S302), and thereafter the completes the control process in the case where the touch panel is stored.

In the above control process in the case where the touch panel is stored, when the operation panel 2 is in the intermediate state, the output of the signal is stopped, so that the shifting to an unintentional screen on the display screen 21 by a user touching the touch panel 22 of the operation panel 2 in the intermediate state can be prevented. Further, when the operation panel 2 is in the intermediate state, the output of the signal is stopped, so that an unintentional operation of the image forming apparatus 1 by a user touching the touch panel 22 of the operation panel 2 in the intermediate state can be prevented.

### Control Process in the Case where Display Portion is Exposed

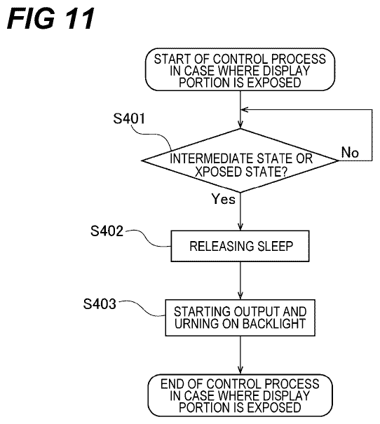

The control process in the case where the display portion is exposed, performed by the image forming apparatus 1 according to the first embodiment of the present invention will be described in detail with reference to FIG. 11.

The control process in the case where the display portion is exposed, shown in FIG. 11 starts at the time when the panel state detection process shown in FIG. 8 detects that the operation panel 2 is in the stored state.

First, the CPU 100 judges whether the result judged by the panel state detection process shown in FIG. 8 is in the intermediate state or in the exposed state (step S401).

When the operation panel 2 is in the stored state (step S401: No), the CPU 100 watches whether the operation panel 2 has shifted from the stored state to the intermediate state or to the exposed state by repeating the process of the step S401.

In contrast, when the result judged by the panel state detection process is in the intermediate state or in the exposed state (step S401: Yes), the process necessary for the operation panel 2 to shift from the stored state to the exposed state. Specifically, the CPU 100 releases the sleep mode by shifting form the sleep mode to the stand-by mode and stars the power supply of the power supply device 12 to the operation panel 2 (step S402).

Next, the CPU 100 starts outputting the display image data to the operation panel 2 and outputs a control signal indicating turn-on of the backlight of the display portion 21. The CPU 200 controls the backlight of the display portion 21 to turn on by the control signal output from the CPU 100 being input to the CPU 200 (step S403). When the CPU 200 performs a control for displaying an image on the display portion 21, the CPU 200 performs a control for displaying an image of the image data stored in the ROM 201. After that, the CPU 100 completes the control process in the case where the display portion is exposed.

When the main power source is ON and the backlight is not turned on in shifting from the stored state to the intermediate state, the main power source may be turned off by mistake because of user's misunderstanding that the main power source is OFF. Further, the CPU 100 can continue the ON state of the backlight of the display portion 21 after the operation panel 2 has been in the exposed state.

In the control process in the case where the display portion is exposed, in the intermediate state, the CPU 100 may gradually increase the light amount of the backlight of the display portion 21 in response to the exposed amount of the operation panel 2 from the apparatus main body 1a or the elapsed time from the time when the operation panel has shifted to the intermediate state. Further, the CPU 100 may perform such a control that the light amount of the backlight of the display portion 21 in the exposed state is larger than that in the intermediate state. With this configuration, the power consumption can be suppressed.

Further, the CPU may only perform the image output to the operation panel 2 in the initial stage of the intermediate state, and thereafter may turn on the backlight of the display portion 21 in response to the exposed amount of the operation panel 2 or the elapsed time after that. With this configuration, the flicker of the display portion 21 can be suppressed.

### Control Process in the Case where Touch Panel is Exposed

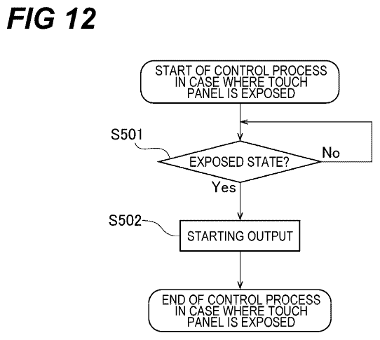

The control process in the case where the touch panel is exposed, performed by the image forming apparatus 1 according to the first embodiment of the present invention will be described in detail with reference to FIG. 12.

The control process in the case where the touch panel is exposed, shown in FIG. 12 starts at the time when an electrical signal output from the CPU 100 indicating that the operation panel 2 is in the stored state or in the intermediate state is input to the CPU 200.

First, the CPU 200 judges whether the operation panel 2 is in the exposed state based on an electrical signal input from the CPU 100 in response to the state of the operation panel 2 (step S501).

When the operation panel 2 is in the stored state or in the intermediate state (step S501: No), the CPU 200 repeats the process of the step S501.

In contrast, when the operation panel 2 is in the exposed state (step S501: Yes), the process necessary for the operation panel 2 to shift from the store state to the exposed state. Specifically, the CPU 200 starts the output to the controller 10 a signal in response to the detection result of the position of the coordinates indicated by an electrical signal input from the touch panel controller 220 (step S502), and thereafter the completes the control process in the case where the touch panel is exposed.

By performing the control process in the case where the touch panel is exposed, the step of a user for returning a screen of the display portion 21 can be omitted, leading to an improvement of work efficiency. Further, the time period from the the time when the operation panel 2 becomes in the exposed state to the time when the touch panel 22 becomes ready for operation can be reduced, leading to an improvement of work efficiency.

As described above, by performing the control process in the case where the touch panel is stored and the control process in the case where the touch panel is exposed, a decrease in workability due to misdetection when the operation panel 2 shifts from the stored state to the exposed state or from the exposed state to the stored state.

In the present embodiment, the apparatus main body 1a is provided that has the image forming portion 15 that forms an image on the sheet S. Further, the operation panel 2 having In the present embodiment, the apparatus main body 1a is provided that has the image forming portion 15 that forms an image on the sheet S. Further, the display portion 21 is provided that displays information on image formation and whose brightness can be changed. The operation panel 2 can be moved between the first position where the entirety of the display portion 21 is exposed from the apparatus main body 1a and the second position where the operation panel 2 is stored in the apparatus main body 1a such that at least a part of the display portion 21 is invisible from outside the apparatus main body 1a. The display portion 21 has a first brightness when the operation panel 2 is in the first position and has a second brightness darker than the first brightness when the operation panel 2 is in the second position.

With this configuration, when the operation panel 2 is not used, the operation panel 2 does not become an obstacle and the power consumption can be reduced.

The present invention is not limited to the above described embodiment and can be changed without departing from the gist of the present invention.

Specifically, in the embodiment of the present invention, the CPU 100 performs the control of the power supply device 12 and the control of the based on an electrical signal input from the detection sensor 30 and the detection sensor 31. However, the configuration is limited to this one and the CPU 200 performs the control of the power supply device 12 and the control of the based on an electrical signal input from the detection sensor 30 and the detection sensor 31.

Further, in the embodiment of the present invention, when the CPU 100 judges that the operation panel 2 is in the stored state in the step S201 of the control process in the case where the display portion is stored shown in FIG. 9, the backlight of the display portion 21 is turned off. However, the configuration is not limited to this one and the CPU 100 may turn off the backlight of the display portion 21 after a predetermined time period has elapsed from the time when the detection sensor 31 detects that the operation panel 2 is in the stored state.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-47848, filed Mar. 25, 2024, which is hereby incorporated by reference herein in its entirety.

What is claimed is:

1. An image forming apparatus comprising:
an apparatus main body having an image forming portion that forms an image on a recording material;
an operation portion having a display portion that displays information on image forming and whose brightness can be changed, the operation portion being able to be moved between a first position where the entirety of the display portion is exposed from the apparatus main body and a second position where the operation portion is stored in the apparatus main body such that at least a part of the display portion is invisible from outside the apparatus main body,
wherein the display portion has a first brightness when the operation portion is in the first position and the display portion has a second brightness darker than the first brightness when the operation portion is in the second position.

2. The image forming apparatus according to claim 1,
wherein the display portion is turned off when the operation portion is in the second position.

3. The image forming apparatus according to claim 1,
wherein the display portion accepts user's touch operations.

4. The image forming apparatus according to claim 3,
wherein the operation portion works based on the touch operations when the operation portion is in the first position and the operation portion does not work based on the touch operations when the operation portion is in the second position.

5. The image forming apparatus according to claim 3,
wherein the operation portion calculates coordinates corresponding to a position on a surface of the display portion which a user touches and has an output portion that outputs a signal based on the coordinates; and
wherein the image forming apparatus has a controller that controls the operation of the operation portion bases on the signal.

6. The image forming apparatus according to claim 5,
wherein the output portion outputs the signal when the operation portion is in the first position and the output portion does not output the signal when the operation portion is in the second position.

7. The image forming apparatus according to claim 5,
wherein the output portion outputs the signal irrespective of a position of the operation portion, and
wherein the controller controls the operation portion bases on the signal when the operation portion is in the first position and the controller does not control the operation portion when the operation portion is in the second position.

8. The image forming apparatus according to claim 1, further comprising:
a first sensor that detects that the operation portion is in the first position; and
a second sensor that detects that the operation portion is in the second position.

9. The image forming apparatus according to claim 8,
wherein the display portion accepts user's touch operations, and
wherein the operation portion works based on the touch operation when the first sensor detects that the operation portion is in the first position, and the operation portion does not work based on the touch operation when the second sensor detects that the operation portion is in the second position.

10. The image forming apparatus according to claim 1,
wherein at least a part of the display portion is visible outside the apparatus main body when the operation portion is in the second position, and
wherein the operation portion is movable to the first position, the second position, and the third position where the entirety of the display portion is stored in the apparatus main body.

11. The image forming apparatus according to claim 10,
wherein the display portion has a third brightness that is darker than the second brightness when the operation portion is in the third position.

12. The image forming apparatus according to claim 10,
wherein the display portion is turned off when the operation portion is in the third position.

13. The image forming apparatus according to claim 1,
wherein the image forming apparatus is able to shift to a first power mode where an image can be formed on a recording material and to a second power mode whose power consumption is less than that of the first power mode.

14. The image forming apparatus according to claim 13,
wherein when the current power mode is the first power mode and the operation portion has moved from the first position to the second position and a first time period has elapsed, the operation portion shifts to the second power mode.

15. The image forming apparatus according to claim 14,
wherein when a second period of time has elapsed in a case where the operation portion is in the first position and the image forming apparatus is in the first power mode, the image forming apparatus shifts to the second power mode.

16. The image forming apparatus according to claim 15,
wherein the first time period is shorter than the second time period.

17. The image forming apparatus according to claim 15,
wherein the first time period and the second time period can be changed based on a user's operations.
